(19) United States
(12) Patent Application Publication
(10) Pub. No.: US 2014/0114935 A1
(43) Pub. Date: Apr. 24, 2014

(54) METHOD OF COMPRESSING TEST FILE

(71) Applicants: Hui Xu, Shanghai (CN); Jianhua Qi, Shanghai (CN); Zhiyong Zhang, Shanghai (CN); Shouyin Ye, Shanghai (CN)

(72) Inventors: Hui Xu, Shanghai (CN); Jianhua Qi, Shanghai (CN); Zhiyong Zhang, Shanghai (CN); Shouyin Ye, Shanghai (CN)

(73) Assignee: SINO IC TECHNOLOGY CO., LTD., Shanghai (CN)

(21) Appl. No.: 13/504,622

(22) PCT Filed: May 17, 2011
(86) PCT No.: PCT/CN11/74139

§ 371 Date: Apr. 27, 2012

(51) Int. Cl. G06F 17/30

(52) U.S. Cl. CPC G06F 17/30153
USPC 707/693

(57) ABSTRACT

A compression method for compressing an original test file is disclosed. The compression method includes the following steps: defining type modules; scanning the original test file line by line in bytes and matching data of the original test file with the type modules to determine types of the data; compressing continuous data of the same type in lines and representing each compressed portion with a thumbnail. The compression method enables a browser to read test files with a fast speed by compressing test files according to the types of data.

### TECHNICAL FIELD

The present invention relates to the field of test, and more particularly, to a method of compressing test files.

### BACKGROUND ART

A test file generated in the field of integrated circuit test, such as a file of VEC format, WGL format, ATP format, etc., generally requires a storage capacity much larger than 2G. It is difficult for conventional browsers (e.g. UE) to read such large-sized files. Even if the files are able to be read, the speed of reading could be very slow. Therefore, how to use a browser to read large-sized test files with a fast speed is an urgent problem to be solved.

### SUMMARY OF THE INVENTION

An objective of the present invention is to provide a method of compressing test file according to the types of data to enable a browser to read test files with a fast speed.

To achieve the above objective, the present invention provides a method of compressing test file used for compressing original test files. The compression method includes the following steps: define type modules; scan the original test file line by line in bytes and match the data of the original test file with the type modules to determine the types of the data; compress continuous data of the same type in lines and represent each compressed portion with a thumbnail.

In the above method of compressing test file, wherein the type modules are defined according to types of data of a text file; each type module corresponds to a type of data; the type module defines the characteristics of the corresponding type of data.

In the above method of compressing test file, wherein the original test file is in a format of VEC, WGL or ATP.

In the above method of compressing test file, wherein the types of the data of the original test file is determined according to the characteristics of the corresponding types of data defined by the type modules.

In the above method of compressing test file, wherein in the original test file, if the data in a line are of different types, then compress continuous data of the same type together and represent each compressed portion with a thumbnail; if the data in a line are of the same type, then compress the data of the line together and represent them with a thumbnail; if multiple lines of continuous data are of the same type and the number of lines of the multiple lines of continuous data is less than or equal to a set value, then compress the multiple lines of continuous data together and represent them with a thumbnail; if multiple lines of continuous data are of the same type and the number of lines of the multiple lines of continuous data is greater than the set value, then divide the multiple lines of continuous data into portions, compress each portion separately, and represent each compressed portion with a thumbnail, wherein the number of lines contained in each portion is less than or equal to the set value, and the lines contained in each portion are continuous.

In the above method of compressing test file, wherein the thumbnail includes a brief description, a plus sign “+” and a minus sign “−”; the brief description is used to give a simple introduction to the content of the compressed portion corresponding to the thumbnail; the plus sign “+” is used to open the detailed content of the compressed portion corresponding to the thumbnail; the minus sign “−” is used to close the opened detailed content of the compressed portion corresponding to the thumbnail.

The method of compressing test file of the present invention compresses the original test file in lines according to the types of data and represents each compressed portion with a thumbnail, and therefore, when reading a large-sized test file by using a browser, there is no need to read out all the contents of the test file at a single time. The contents can be selectively read portion by portion. This may greatly improve the speed of reading.

### BRIEF DESCRIPTION OF THE DRAWINGS

FIG. 1 is a flow chart illustrating the method of compressing test file of the present invention.

### DETAILED DESCRIPTION

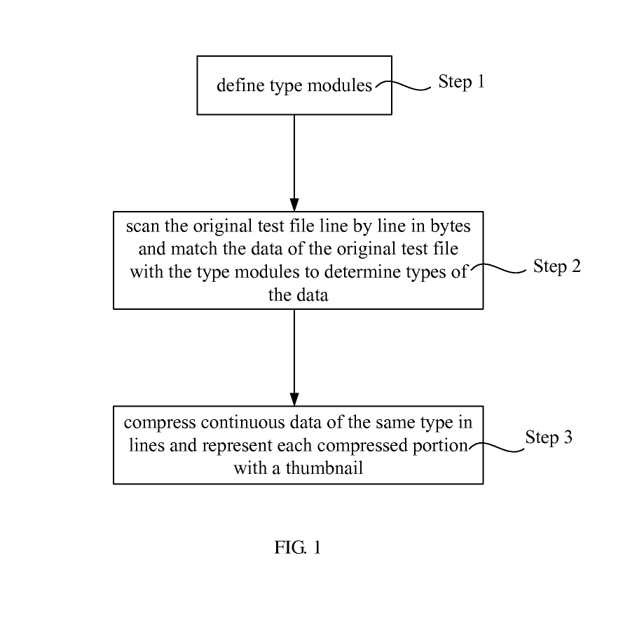

The method of compressing test file of the present invention will be further described in details by reference to FIG. 1.

Referring to FIG. 1, the method of compressing test file of the present invention includes the following steps:

Step 1, define type modules.

The type modules are defined according to the types of data of an ordinary text file (i.e. TXT file). Generally, the contents of a text file are represented by different types of data (or in other words, a text file is composed of different types of data), for example, character data, digital data, timing data, name data and programming language data. The type modules are defined according to the types of data that could be contained in an ordinary text file, for example, character data module, digital data module, timing data module, name data module and programming language data module can be defined.

Each type module corresponds to a type of data and the type module defines the characteristics of the corresponding type of data.

Step 2, scan the original test file line by line in bytes and match the data of the original test file with the type modules defined in Step 1 to determine the types of the data.

In the method of compressing test file of the present invention, the original test file is regarded as a vector file, and each line of the original test file is regarded as a vector. Therefore, the original test file is scanned line by line in bytes to determine the types of the data of the original test file.

The original test file can be in the format of, for example, VEC, WGL or ATP.

Each of the data of the original test file will be matched with the type modules to determine the types of the data. The types of the data of the original test file are determined based on the characteristics of various types of data defined by the corresponding type modules.

Step 3, compress continuous data of the same type in lines and represent each compressed portion with a thumbnail.

If multiple types of data are contained in a line of data in the original test file, compress those continuous data of the same type together, namely compress the line of data according to the type of data and location of the data. The data to be compressed together are not only of the same type, but also arranged continuously in the line. Each compressed portion is represented by a thumbnail. For example, a certain line of data in the original test file is read as “the test result of the sample of the third group is 0111110011110”; since the data in this line are of two types: the first type is character data and the second type is digital data; all the character data in this line are continuously arranged and all the digital data in this line are continuously arranged; all the character data of this line “the test result of the sample of the third group is” are compressed together and are represented by a thumbnail, while all the digital data of this line “0111110011110” are compressed together and are also represented by a thumbnail.

In case that all the data in a line are of the same type of data, then compress the data in the line together and represent them with a thumbnail.

In case that multiple lines of continuous data are of the same type of data and the number of lines of the continuous data is less than or equal to a set value, then compress the multiple lines of data together and represent them with a thumbnail.

In case that multiple lines of continuous data are of the same type of data and the number of lines of the continuous data is greater than the set value, then divide the multiple lines of continuous data into several portions, compress each portion separately, and represent each compressed portion with a thumbnail. Wherein, the number of lines contained in each portion is less than or equal to the set value, and the lines contained in each portion are continuously arranged. For example, an original test file has 2.2 million lines of continuous digital data. If all these digital data of 2.2 million lines are compressed together, it will require a relatively large storage capacity and the speed of reading would be slow. Here, we set the number of lines contained in each compressed file to be no more than 0.5 million. Then the 2.2 million lines of digital data may be divided into 5 portions, each portion containing no more than 0.5 million lines of data. Compress each portion separately and represent each compressed portion with a thumbnail. That is to say, by using the method of compressing test file of the present invention, the 2.2 million lines of digital data can be displayed as 5 thumbnails.

An original test file compressed by the method of the present invention can be displayed as a test file constituted of thumbnails. In other words, the test file compressed by the method of the present invention does not display the specific contents of the test file. Instead, the compressed contents are represented by a series of thumbnails. As the original test file is regarded as a vector file and each line of the original test file is regarded as a vector in the method of the present invention, the original test file is compressed in lines and the compressed test file has the same layout as the original test file.

A thumbnail contains a brief description, a plus sign “+” and a minus sign “−”. The brief description is used to give a simple introduction to the content of the compressed portion corresponding to the thumbnail. The plus sign “+” is used to open the specific content of the compressed portion corresponding to the thumbnail. The minus sign “−” is used to close the specific content of the compressed portion corresponding to the thumbnail that has been opened. As the compressed test file does not display specific contents of the test file, when reading the compressed test file with a browser, one may firstly have an overview of the content of the compressed portion corresponding to the thumbnail through the brief description of the thumbnail, and then open the specific content of the compressed portion corresponding to the thumbnail by clicking the plus sign “+” of the thumbnail, and close the specific content that has been opened by clicking the minus sign “−” of the thumbnail.

The method of compressing test file of the present invention compresses the original test file in lines according to the types of data and represents each compressed portion with a thumbnail, in this way the compressed test file can be read in part, in other words, when reading a large-sized test file with a browser, there is no need to read out all the contents of the test file at a single time. The contents can be selectively read portion by portion. This may greatly improve the speed of reading.

In the method of compressing test file of the present invention, the type modules are defined according to the types of data of a text file. When reading a compressed test file with a browser, the compressed test file is displayed in the same way as a text file. The same operations, such as copying, pasting, selecting and modifying, that can be applied to a text file may also be applied to the compressed test file.

What is claimed is:

1. A method of compressing test file, used for compressing an original test file, comprising the following steps:
defining type modules;
scanning the original test file line by line in bytes and matching data of the original test file with the type modules to determine types of the data of the original test file;
compressing continuous data of the same type in lines and representing each compressed portion with a thumbnail.

2. The method of compressing test file according to claim 1, wherein the type modules are defined according to types of data of a text file, each type module corresponding to a type of data, the type module defining characteristics of the corresponding type of data.

3. The method of compressing test file according to claim 1, wherein the original test file is in a format of VEC, WGL or ATP.

4. The method of compressing test file according to claim 2, wherein the types of the data of the original test file are determined according to the characteristics of the types of data defined by the type modules.

5. The method of compressing test file according to claim 1, wherein:
when the data in a line are of different types in the original test file, compress continuous data of a same type together and represent each compressed portion with a thumbnail;
when the data in a line are of a same type in the original test file, compress the data in the line together and represent the compressed portion with a thumbnail;
when multiple lines of continuous data in the original test file are of a same type and a number of lines of the multiple lines of continuous data is less than or equal to a set value, compress the multiple lines of continuous data together and represent the compressed portion with a thumbnail;
when multiple lines of continuous data in the original test file are of a same type and a number of lines of the multiple lines of continuous data is greater than the set value, divide the multiple lines of continuous data into a plurality of portions, compress each portion separately, and represent each compressed portion with a thumbnail, wherein a number of lines contained in each portion is less than or equal to the set value, and the lines contained in each portion are continuous.

6. The method of compressing test file according to claim 5, wherein the thumbnail includes a brief description, a plus sign “+” and a minus sign “−”, the brief description being used to give a simple introduction to a content of the compressed portion corresponding to the thumbnail, the plus sign “+” being used to open a specific content of the compressed portion corresponding to the thumbnail, the minus sign “−” being used to close the opened specific content of the compressed portion corresponding to the thumbnail.
